(19) United States
(12) Patent Application Publication
(10) Pub. No.: US 2011/0194027 A1
(43) Pub. Date: Aug. 11, 2011

(54) IMAGE UPDATE SYSTEM, DIGITAL PHOTO FRAME, AND IMAGE UPDATE METHOD

(75) Inventors: RUEY-SHYANG YOU, Tu-Cheng (TW); BIN-GANG DUAN, Shenzhen City (CN)

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/774,693

(22) Filed: May 5, 2010

(30) Foreign Application Priority Data
Feb. 6, 2010 (CN) 201010110160.3

(51) Int. Cl. H04N 3/27; H04N 3/14

(52) U.S. Cl. 348/554; 348/790; 348/E03.049; 348/E03.016

(57) ABSTRACT

The present disclosure provides an image update system. The image update system includes a portable device and a digital photo frame (DPF). The portable device selects at least one image stored in the portable electronic device in response to user input, and generates a display command. The portable device transmits the at least one selected image and the display command to the DPF. The DPF receives the at least one selected image and the display command, and then instantly displays the at least one selected image on the PDF according to the display command. A related DPF and an image update method applied in the DPF are also provided.

### BACKGROUND

1. Technical Field

The present disclosure generally relates to content update systems and, particularly, to an image update system, a digital photo frame (DPF), and an image update method applied in a DPF.

2. Description of the Related Art

When an image is stored in a DPF, the DPF cannot display the image instantly and automatically. That is, if a user wants to view the image once it is stored in the DPF, the user has to operate the DPF to cause the image to be displayed, which may be not convenient to users.

### BRIEF DESCRIPTION OF THE DRAWINGS

The components in the drawings are not necessarily drawn to scale, the emphasis instead being placed upon clearly illustrating the principles of an image update system, a digital photo frame (DPF), and an image update method. Moreover, in the drawings, like reference numerals designate corresponding parts throughout the several views.

FIG. 1 is a schematic view of an image update system in accordance with an exemplary embodiment.

FIG. 2 is a block diagram of the image update system of FIG. 1, in accordance with an exemplary embodiment.

FIG. 3 is a flowchart of an image update method in accordance with an exemplary embodiment.

### DETAILED DESCRIPTION

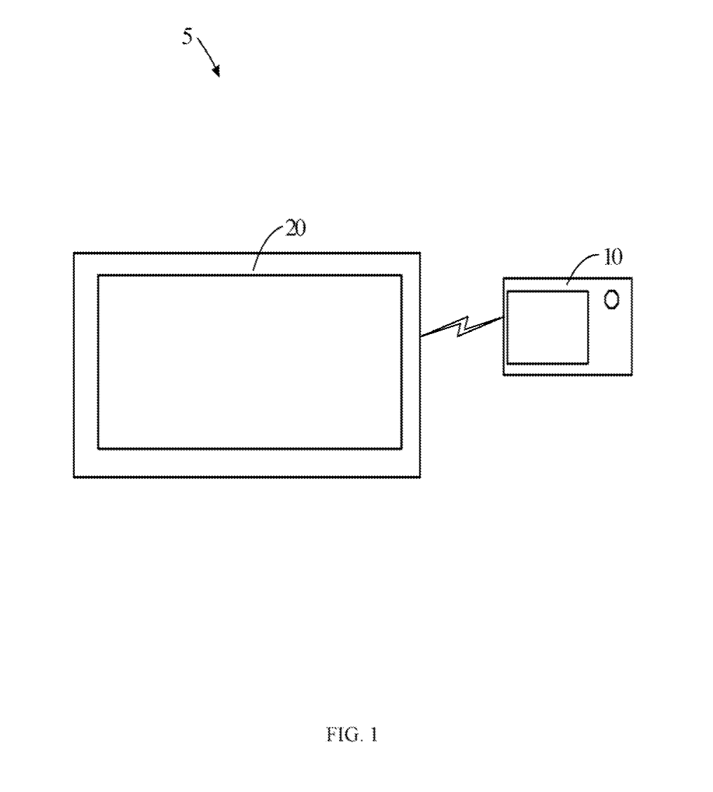

Referring to FIG. 1, an image update system 5 includes a portable electronic device 10 and a DPF 20. The portable electronic device 10 is configured for transmitting at least one selected image and a display command to the DPF 20. The DPF 20 is configured for instantly displaying the at least one selected image according to the display command The portable electronic device 10 can be a mobile phone, an e-reader, a PDA, a digital camera, or the like.

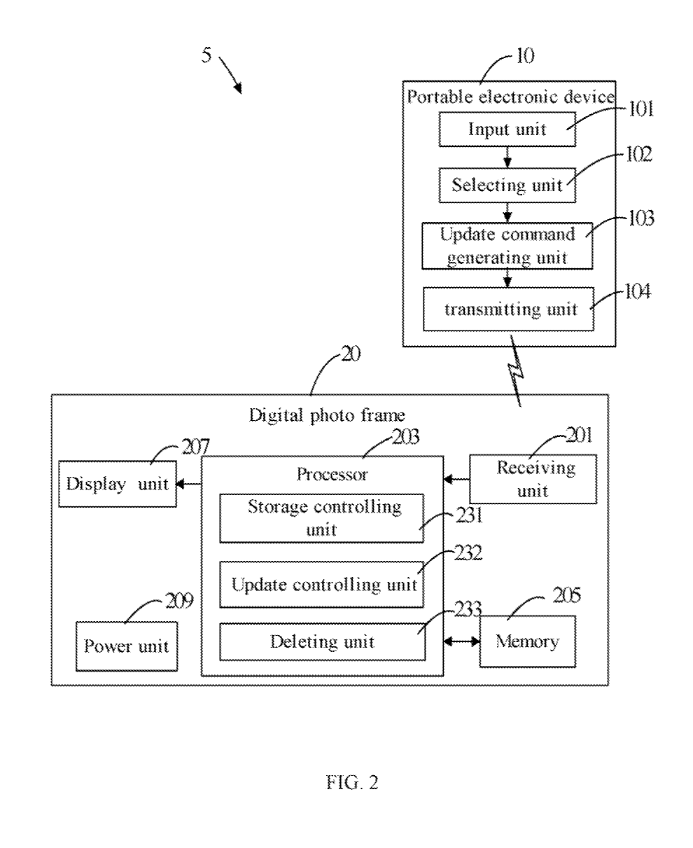

Referring also to FIG. 2, the portable electronic device 10 includes an input unit 101, a selecting unit 102, a display command generating unit 103, and a transmitting unit 104. The input unit 101 is configured for generating a selection signal in response to a user selecting at least one image. The input unit 101 can be a physical button, or a soft key expressed by a displayed icon. The selecting unit 102 is configured for selecting the at least one image from the portable electronic device 10 according to the selection signal. The display command generating unit 103 is configured for automatically generating a display command once the selecting unit 102 selects the at least one image. The transmitting unit 104 is configured for transmitting the display command and the at least one selected image to the DPF 20. In the embodiment, the transmitting unit 104 can be a BLUETOOTH transmitter, an infrared transmitter, or a WIFI transmitter.

The DPF 20 includes a receiving unit 201, a processor 203, a memory 205, a display unit 207, and a power unit 209.

The receiving unit 201 is configured for receiving the display command and the at least one selected image transmitted from the transmitting unit 104. In the exemplary embodiment, the receiving unit 201 can be a BLUETOOTH receiver, an infrared receiver, or a WIFI receiver.

The processor 203 includes a storage controlling unit 231 and a display controlling unit 232. The storage controlling unit 231 is configured for storing the at least one selected image in the memory 205. The display controlling unit 232 is configured for instantly displaying the at least one selected image on the display unit 207 according to the display command. In the embodiment, if the at least one selected image includes a plurality of images, the display controlling unit 232 displays the plurality of images on the display unit 207 in a predetermined mode. In the predetermined mode, the display unit 207 displays all of the plurality of images simultaneously, or displays the plurality of images one by one in slideshow style, or displays one of the plurality of images randomly. In the embodiment, the display unit 207 can be an electrophoretic display (EPD), an electrowetting display (EWD), or a cholesteric liquid crystal display (ChLCD).

In the embodiment, the processor 203 further includes a deleting unit 233. The deleting unit 233 is configured for automatically deleting the at least one selected image from the memory 205 after the at least one selected image has been displayed on the display unit 207. Thus, the memory 205 can be a flash memory with small capacity. In an alternative embodiment, the input unit 101 generates a delete command in response to a user initiated delete command regarding the at least one selected image, the transmitting unit 104 transmits the delete command to the DPF 20, the deleting unit 233 receives the delete command and deletes the at least one selected image in response.

The power unit 207 is configured for providing power to the DPF 20. In the embodiment, the power unit 207 is a solar energy supply unit.

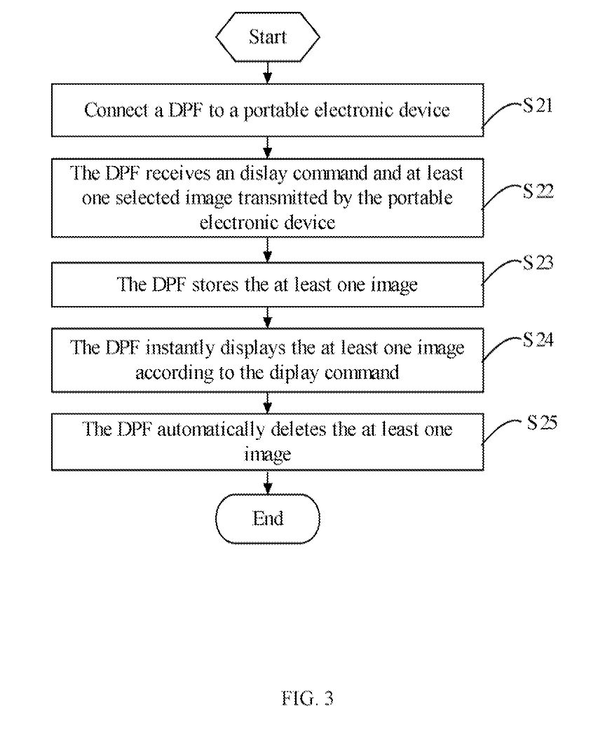

FIG. 3 is a flowchart of illustrating an image update method applied in a DPF 20 of the image update system 5 in accordance with an exemplary embodiment.

In step S21, the DPF 20 is connected to the portable electronic device 10 via establishing a connection between the transmitting unit 104 and the receiving unit 201.

In step S22, the receiving unit 201 receives the at least one selected image and the display command transmitted from the portable device 10.

In step S23, the storage controlling unit 231 stores the at least one selected image in the memory 205.

In step S24, the display controlling unit 232 instantly displays the at least one selected image according to the display command. In the embodiment, if the at least one selected image includes a plurality of images, the display controlling unit 232 displays the plurality of images on the display unit 207 in the predetermined mode.

In step S25, the deleting unit 233 automatically deletes the at least one image after the at least one image has been displayed. In an alternative embodiment, the deleting unit 233 receives the delete command and deletes the at least one selected image in response to the deleting command

It is understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An image update system, comprising a portable electronic device and a digital photo frame (DPF), wherein:
the portable electronic device comprises:
an input unit for generating a selecting signal in response to a user selecting at least one image;
a selecting unit for selecting the at least one image from the portable electronic device according to the selecting signal;
a display command generating unit for automatically generating a display command once the selecting unit selects the at least one image; and
a transmitting unit for transmitting the display command and the at least one selected image to the DPF;
the DPF comprises:
a memory;
a display unit;
a receiving unit for receiving the display command and the at least one selected image transmitted from the transmitting unit;
a storage controlling unit for storing the at least one selected image in the memory; and
a display controlling unit for instantly displaying the at least one selected image on the display unit according to the display command

2. The image update system as claimed in claim 1, wherein the DPF further comprising a power unit is for providing power to the DPF.

3. The image update system as claimed in claim 2, wherein the power unit is a solar energy supply unit.

4. The image update system as claimed in claim 1, wherein the DPF further comprising a deleting unit configured for automatically deleting the at least one selected image from the memory after the at least one selected image has been displayed on the display unit.

5. The image update system as described in claim 1, wherein the input unit is further for generating a delete command in response to a user initiated delete command regarding the at least one selected image, the transmitting unit transmits the delete command to the DPF, the deleting unit receives the delete command and deletes the at least one selected image in response.

6. The image update system as claimed in claim 1, wherein if the at least one selected image comprises a plurality of images, the display controlling unit displays the plurality of images on the display unit.

7. The image update system as claimed in claim 1, wherein the display unit can be an electrophoretic display (EPD), an electrowetting display (EWD), or a cholesteric liquid crystal display (ChLCD).

8. A digital photo frame (DPF) capable of being controlled by a portable device, comprising:
a memory;
a display unit;
a receiving unit configured for receiving an display command and at least one image transmitted by the portable device;
a storage controlling unit configured for storing the at least one image in the memory; and
a display controlling unit configured for displaying the at least one image on the display unit according to the display command

9. The DPF as claimed in claim 8, further comprising a power unit configured for providing power to the DPF.

10. The DPF as claimed in claim 9, wherein the power unit is a solar energy supply unit.

11. The DPF as claimed in claim 8, further comprising a deleting unit configured for automatically deleting the at least one image from the memory after the at least one image has been displayed on the display unit.

12. The DPF as described in claim 8, further comprising a deleting unit configured for receiving a delete command transmitted from the portable device, and deleting the at least one selected image according to the delete command

13. The DPF as claimed in claim 8, wherein if the at least one selected image comprises a plurality of images, the display controlling unit displays the plurality of images on the display unit.

14. The DPF as claimed in claim 8, wherein the display unit can be an electrophoretic display (EPD), an electrowetting display (EWD), or a cholesteric liquid crystal display (ChLCD).

15. An image update method applied in a digital photo frame (DPF) comprising:
connecting the DPF to a portable electronic device;
receiving a display command and at least one image transmitted by the portable electronic device;
storing the at least one image; and
instantly displaying the at least one image according to the display command.

16. The image update method as claimed in claim 15, further comprising:
automatically deleting the at least one selected image from the DPF after the at least one image has been displayed.

17. The image update method as claimed in claim 15, further comprising:
displaying the at least one image if the at least one image comprises a plurality of images.

18. The image update method as claimed in claim 15, further comprising:
receiving a deleting command; and
deleting the at least one image in response to the deleting command.
